(19) United States
(12) Patent Application Publication
(10) Pub. No.: US 2004/0227974 A1
(43) Pub. Date: Nov. 18, 2004

(54) Image processing system, scanner device and image processing method

(75) Inventor: Masahiro Hatashita, Sohraku-gun (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/772,074

(22) Filed: Feb. 4, 2004

(30) Foreign Application Priority Data
May 14, 2003 (JP) 2003-135319

(51) Int. Cl. G06F 3/00; G06F 15/00; H04N 1/04

(52) U.S. Cl. 358/1.15; 358/474; 710/8

(57) ABSTRACT

An image processing system includes a scanner device that scans an original document and obtains scanned data, a printer device that prints out image data and a personal computer. An interface establishes a Universal Serial Bus (USB) connection between the personal computer and the scanner device with the personal computer acting as a host terminal and the scanner device acting as a device terminal. Another interface establishes a USB connection between the scanner device and the printer device with the scanner device acting as the host terminal and the printer device acting as the device terminal.

### BACKGROUND OF THE INVENTION

1. Field of the Invention

The present invention relates to an image processing system including a scanner device, a printer device and a personal computer (PC).

2. Description of the Related Art

A general image processing system includes a scanner device, a printer device and a client PC which are connected by a Local Area Network (LAN). In the image processing system, PC printing is carried out. That is, print data is transmitted from the client PC to the printer device, and the printer device prints out the print data. In addition, PC scanning is carried out in the image processing system. That is, the scanner device scans an original document and the client PC obtains the scanned data.

Instead of connecting the scanner device, the printer device and the client PC by the LAN, the scanner device, the printer device and the client PC can be connected by a Universal Serial Bus (USB). The USB is a communication method where one terminal acts as a host terminal and another terminal acts as a device terminal and data is transmitted and received between the two terminals. To carry out copying, it is necessary to connect the scanner device and the printer device. To carry out PC printing and/or PC scanning, it is necessary to connect the client PC and the printer device and/or the scanner device. To carry out copying, PC printing and PC scanning by the USB connection, it is necessary to establish a USB connection between each of the scanner device and the printer device, between the client PC and the printer device, and between the client PC and the scanner device, respectively. In this case, for example, it is necessary for the printer device to include a USB interface (I/F) for establishing a connection with the scanner device and another USB I/F for establishing a connection with the client PC.

### SUMMARY OF THE INVENTION

An advantage of the present invention is to provide a system which carries out copying, PC printing and PC scanning by establishing a USB connection between a scanner device, a printer device and a client PC under a simple configuration.

According to the present invention, an image processing system includes a scanner device which scans an original document and obtains scanned data, a printer device which prints out image data, and a personal computer. With the personal computer acting as a host terminal and the scanner device acting as a device terminal, a USB connection is established between the personal computer and the scanner device. Moreover, with the scanner device acting as a host terminal and the printer device acting as a device terminal, another USB connection is established between the scanner device and the printer device.

In the image processing system of the present invention, just by providing one USB interface in the printer device, the USB connection can be established between the printer device, the scanner device and the client PC, and the copying, the PC printing and the PC scanning can be carried out.

### BRIEF DESCRIPTION OF THE DRAWINGS

FIG. 1 is a block diagram showing a configuration of an image processing system according to an embodiment of the present invention.

FIG. 2 is a flowchart showing a process carried out by a scanner device when data is received from a PC.

FIG. 3 is a flowchart showing a process carried out by the scanner device when data is received from the PC.

FIG. 4 is a flowchart showing a process carried out by the scanner device when data is received from a printer device.

FIG. 5 is a flowchart showing a process carried out by the scanner device when there is an instruction to start scanning.

### DETAILED DESCRIPTION OF PREFERRED EMBODIMENT

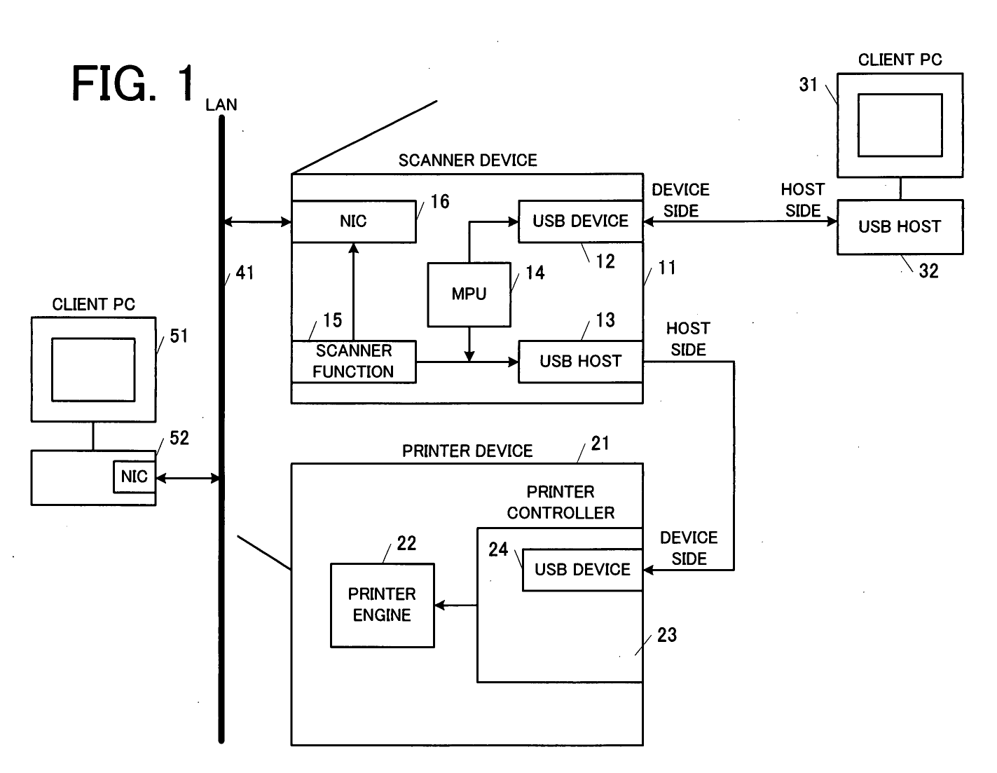

An embodiment of the present invention will be described in detail. FIG. 1 is a block diagram showing a configuration of an image processing system according to an embodiment of the present invention. The image processing system of the present embodiment includes a scanner device 11, a printer device 21 and a client PC 31.

The scanner device 11 includes a USB interface (USB device) 12 which is an interface of a device side, a USB interface (USB host) 13 which is an interface of a host side, a Micro Processing Unit (MPU) 14 for processing control, a scanner function unit 15 which scans an image of an original document to obtain scanned data, and a Network Interface Card (NIC) 16. That is, the scanner device 11 includes two input/output ports for the USB device 12 and the USB host 13. A USB cable is connected to the input/output ports respectively. The scanner device 11 also includes an operation unit, a display unit or the like (not shown). The operation unit includes a copy instruction key for a user to input a copy instruction, and a scanning instruction key for the user to input a scanning instruction.

The printer device 21 includes a printer engine 22, a printer controller 23, and a USB interface (USB device) 24 that is an interface of a device side. The printer device 21 includes one input/output port for the USB device 24. By using the above-described configuration, data can be transmitted and received between the PC 31 and the printer device 21 via the scanner device 11. Therefore, the printer device 21 includes the input/output port for establishing a USB connection with the scanner device 11, but does not include an input/output port for establish a USB connection with the PC 31.

The USB device 12 of the scanner device 11 is connected via the USB cable with a USB interface (USB host) 32 which is an interface of a host side of the client PC 31. The USB host 13 of the scanner device 11 is connected via the USB cable with the USB device 24 of the printer device 21. The NIC 16 of the scanner device 11 is connected to a NIC 52 of a client PC 51 via a cable of a LAN 41. The LAN connection can be a wired connection or a wireless connection.

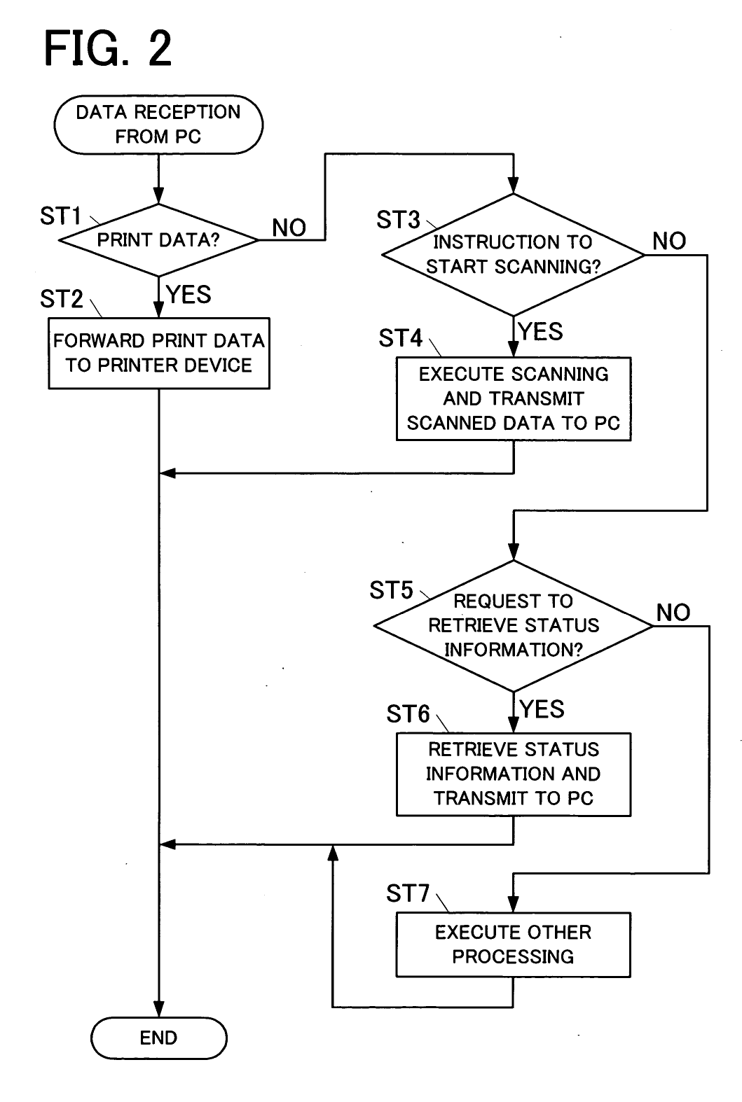

Referring to FIG. 2, a description will be made on a process carried out by the scanner device 11 when data is received from the PC 31 in the image processing system. The scanning process of FIG. 2 is a process relating to the Technology Without Any Interested Name (TWAIN) method. The TWAIN method is a method to execute a scanning process in accordance with an instruction to start the scanning process from the PC and to transmit the obtained scanned data to the PC.

When data is received from the PC 31 via the USB host 32 and the USB device 12 by the USB device function, at step ST1, a determination is made as to whether or not the received data is print data. In case of PC printing where the print data transmitted by the PC31 is transmitted via the scanner device 11 to the printer device 21 and the printing process is executed by the printer device 21, the data received by the scanner device 21 is the print data for PC printing. When the received data is the print data, the process proceeds to step ST2.

Meanwhile, when the received data is not the print data, the process proceeds to step ST3. In case of PC scanning, the scanner device 11 receives from the PC 31, data including the instruction to start the scanning process. At step ST2, to implement the PC printing, the scanner device 11 forwards the print data to the printer device 21 via the USB host 13 and the USB device 24 by the USB host function of the scanner device 11. At step ST3, a determination is made as to whether or not the received data includes the instruction to start the scanning process. When the received data includes the instruction to start the scanning process (in case of PC scanning), the process proceeds to step ST4. Meanwhile, when the received data does not include the instruction to start the scanning process, the process proceeds to step ST5.

At step ST4, a scanning process is executed on the original document, and the obtained scanned data is transmitted to the PC 31 via the USB device 12 and the USB host 32 by the USB device function of the scanner device 11. At step ST5, a determination is made as to whether or not the received data is a request to retrieve status information. When the received data is the request to retrieve the status information, the process proceeds to step ST6. Meanwhile, when the received data is not the request to retrieve the status information, the process proceeds to step ST7.

At step ST6, the stored status information is retrieved, and the status information is transmitted to the PC 31 via the USB device 12 and the USB host 32 by the USB device function of the scanner device 11. Further, under appropriate timing, the scanner device 11 receives the status information of the printer device 21 via the USB device 24 and the USB host 13 by the USB host function of the scanner device 11. Then, the scanner device 11 stores the received status information in a memory. As described above, the status information stored in the memory can be transmitted to the PC 31 in accordance with the retrieving request from the PC 31. At step ST7, other processing is executed.

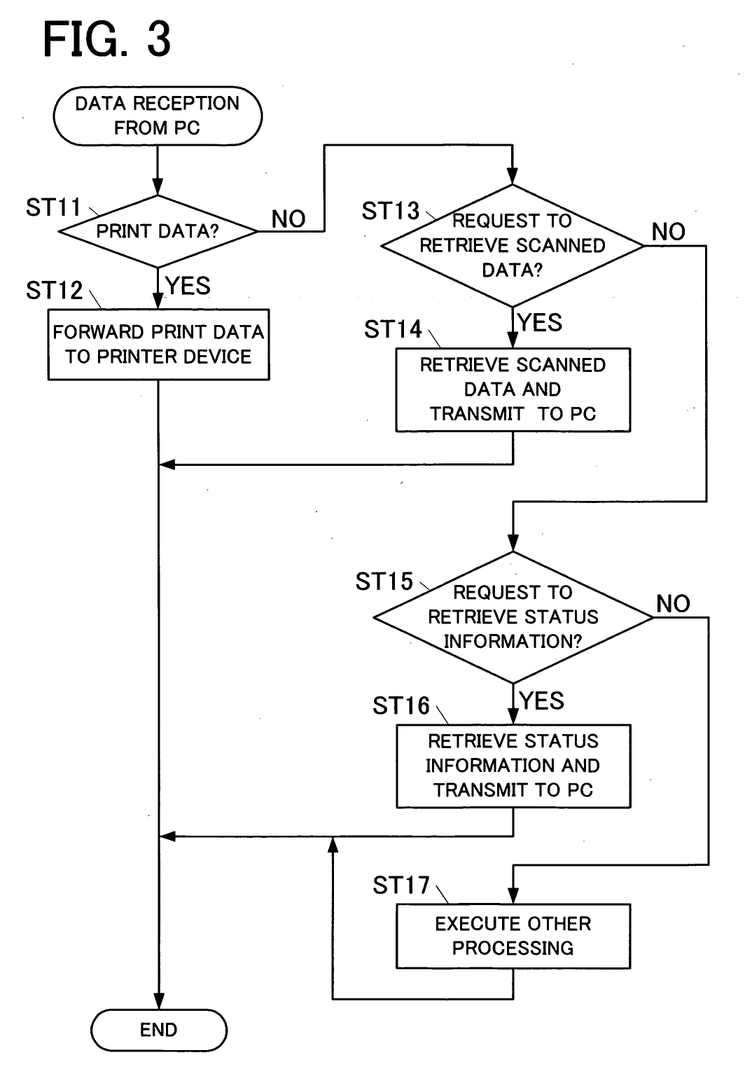

Referring to FIG. 3, a description will be made on the process carried out by the scanner device 11 when data is received from the PC 31. FIG. 3 is a flow diagram of the process when carrying out PC scanning of the box method. The box method is a method where the scanned data is accumulated in the scanner device 11 until receiving the retrieving request from the PC 31, and by transmitting the retrieving request of the scanned data from the PC 31 to the scanner device 11, the scanned data accumulated in the scanner device 11 can be retrieved. That is, under the box method, the scanner device 11 executes the scanning process in accordance with the instruction to start the scanning process from the operation unit of the scanner device 11. Then, the scanner device 11 accumulates the obtained scanned data in a box of the scanner device 11. The scanner device 11 retrieves the accumulated data in accordance with the retrieving request from the PC 31 and transmits the accumulated data to the PC 31. After providing the scanner device 11 with an original document, the user instructs the scanner device 11 to start the scanning process via the operation unit of the scanner device 11, and the scanning process is executed and the scanned data is accumulated in the box (memory). FIG. 3 shows the process under a state in which the scanned data is accumulated in the scanner device 11 in advance.

Also in this case, when data is received from the PC, in step ST11, a determination is made as to whether or not the received data is print data. When the received data is the print data (in case of PC printing), the process proceeds to step ST12. Meanwhile, when the received data is not the print data, the process proceeds to step ST13. At step ST12, as at step ST2 of FIG. 2, the scanner device 11 forwards the print data to the printer device 21 via the USB host 13 and the USB device 24 by the USB host function of the scanner device 11. At step ST13, a determination is made as to whether or not the received data is a request to retrieve the scanned data. When the received data is the request to retrieve the scanned data, the process proceeds to step ST14. Meanwhile, when the received data is not the request to retrieve the scanned data, the process proceeds to step ST15.

At step ST14, the scanned data accumulated in the box is retrieved, and transmitted via the USB device 12 and the USB host 32 to the PC 31, which transmitted the retrieving request, by the USB device function of the scanner device 11. The process subsequent to step ST15 is the same as the process subsequent to step ST5 of FIG. 2.

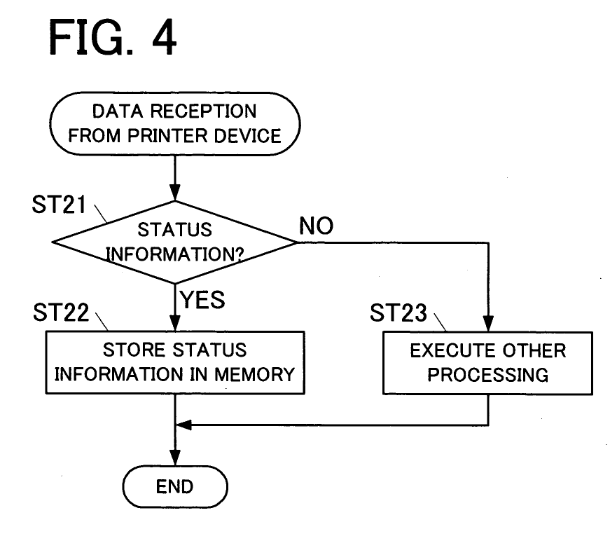

When the scanner device 11 receives data from the printer device 21 via the USB device 24 of the printer device 21 by the USB host function of the scanner device 11, the scanner device 11 executes the process shown in FIG. 4. In FIG. 4, at step ST21, a determination is made as to whether or not the received data is status information. When the received data is status information from the printer device 21 indicating that, for example, paper has run out or an error has been generated, the process proceeds to step ST22. Meanwhile, when the received data is not status information, the process proceeds to step ST23. In step ST22, the received status information is stored in the memory. In step ST23, other processes are executed according to the contents of the received data.

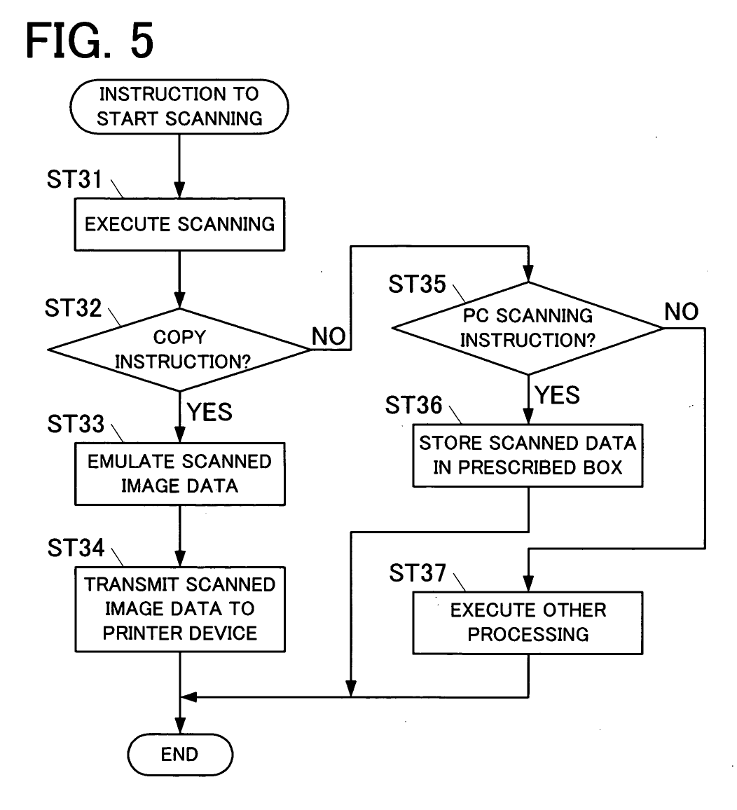

Next, referring to FIG. 5, a description will be made about a process carried out by the scanner device 11 when there is an instruction to start the scanning process. When an instruction is generated to start the scanning process by a copy start instruction or a PC scanning start instruction, the process shown in FIG. 5 is executed. The copy start instruction is input from the operation unit of the scanner device 11. At step ST31, the scanning process is executed. Then, the process proceeds to step ST32. At step ST32, a determination is made as to whether or not there is a copy instruction. When the copy instruction key has been activated from the operation unit, in other words, when there is a copy instruction, the process proceeds to step ST33. Meanwhile, when there has not been a copy instruction, the process proceeds to step ST35.

At step ST33, the scanned data obtained by scanning the original document is emulated into a data format transmitted from the PC to the printer device 21 for PC printing. An example of the data format is the Postscript format. Then, the process proceeds to step ST34. At step ST34, the emulated data is forwarded to the printer controller 23 via the USB host 13 and the USB device 24 by the USB host function of the scanner device 11. The printer device 21 receives by the USB function, the print data for copying forwarded by the scanner device 11. Then, the printer device 21 starts the printer engine 22 and executes the printing process. The copying process can be implemented in the manner described above.

At step ST35, a determination is made as to whether or not the scanning start instruction is the PC scanning instruction. When the scanning start instruction is the PC scanning instruction, the process proceeds to step ST36. Meanwhile, when the scanning start instruction is not the PC scanning instruction, the process proceeds to step ST37. At step ST36, the scanned data is stored in a prescribed box of the scanner device 11. At step ST37, other processing operations are executed.

In the above-described embodiment, when outputting the scanned data to the printer device 21 from the scanner device 11 in the copying process, the data format to be output is emulated (conformed with the data format transmitted from the PC to the printer device for PC printing). Therefore, without adding a special function to an existing printer device having the PC printing function, copying can be carried out by using the scanner device and the printer device which are connected by the USB.

What is claimed is:

1. An image processing system comprising:
a scanner device that scans an original document and obtains scanned data;
a printer device that prints out image data;
a personal computer (PC);
means for establishing a Universal Serial Bus (USB) connection between the PC and the scanner device with the PC acting as a host terminal and the scanner device acting as a device terminal; and
means for establishing a USB connection between the scanner device and the printer device with the scanner device acting as a host terminal and the printer device acting as a device terminal.

2. The image processing system according to claim 1, wherein when carrying out a PC printing operation, the scanner device receives print data from the PC by a USB device function and forwards the print data to the printer device by a USB host function.

3. The image processing system according to claim 1, wherein when carrying out a copying operation, the scanner device transmits the scanned data to the printer device by a USB host function, and when carrying out a PC scanning operation, the scanner device transmits the scanned data to the PC by a USB device function.

4. An image processing system comprising:
a scanner device that scans an image of an original document and outputs scanned data;
a printer device that prints received image data onto a recording medium; and
a remote device;
wherein when one of the devices acts as a host terminal and another device acts as a device terminal, each of the devices is connected by an interface that transmits and receives data by collaboration of a host function of the one of the devices and a device function of the another device;
the remote device and the scanner device are connected with the remote device acting as the host terminal and the scanner device acting as the device terminal; and
the scanner device and the printer device are connected with the scanner device acting as the host terminal and the printer device acting as the device terminal.

5. The image processing system according to claim 4, wherein the interface is a Universal Serial Bus (USB).

6. A scanner device, comprising:
at least two input/output ports for an interface to transmit and receive data by collaboration of a host function of one device and a device function of another device with the one device acting as a host terminal and the other device acting as a device terminal;
wherein when the scanner device acts as the device terminal, a connection can be established with a remote device acting as the host terminal via one of the input/output ports; and
wherein when the scanner device acts as the host terminal, a connection can be established with a printer device acting as the device terminal via the other one of the input/output ports.

7. The scanner device according to claim 6, further comprising:
means for determining whether to forward data received from the remote device by the device function of the scanner device to the printer device; and
means for controlling to forward the data to the printer device by the host function of the scanner device when the means for determining determines to forward the data.

8. The scanner device according to claim 6, further comprising:
means for determining whether or not the data received from the remote device by the device function of the scanner device is an image scanning instruction or an image retrieving request; and
means for controlling to transmit scanned image data by the scanner device to the remote device by the device function of the scanner device when the means for determining determines that the received data is the image scanning instruction or the image retrieving request.

9. The scanner device according to claim 6, further comprising:
means for detecting an input of a copy start instruction; and
means for controlling to scan an original document in accordance with the input of the copy start instruction and to transmit obtained scanned data to the printer device by the host function of the scanner device.

10. The scanner device according to claim 9, further comprising:
means for converting a data format of the scanned data when executing a copying process;
wherein the means for converting converts the scanned data into a same format as a data format received from the remote device to be forwarded to the printer device; and
the means for controlling controls to transmit the scanned data under the data format converted by the means for converting when transmitting the scanned data to the printer device.

11. The scanner device according to claim 6, further comprising:
means for retrieving status information of the printer device by the host function of the scanner device;
means for storing the status information retrieved by the means for retrieving;
means for determining whether or not data received from the remote device by the device function of the scanner device is a status information request; and
means for controlling to transmit to the remote device by the device function of the scanner device, the status information stored in the means for storing, when the means for determining determines that the received data is the status information request.

12. An image processing method comprising:
transmitting print data from a personal computer (PC) to a scanner device using a Universal Serial Bus (USB) host function of the PC and a USB device function of the scanner device when carrying out a PC printing operation; and
transmitting the print data from the scanner device to a printer device using a USB host function of the scanner device and a USB device function of the printer device.

13. The image processing method according to claim 12, further comprising transmitting the scanned data to the printer device by the USB host function of the scanner device when carrying out a copying operation.

14. The image processing method according to claim 12, further comprising:
converting a data format of the scanned data from the scanner device into a same format as a data format received from a remote device to be forwarded to the printer device when carrying out a copying operation; and
transmitting the scanned data under the converted data format to the printer device by the USB host function of the scanner device.

15. The image processing method according to claim 12, further comprising transmitting scanned data from the scanner device to the PC by the USB device function of the scanner device when carrying out a PC scanning operation.

16. An image processing system comprising:
a scanner device that scans an original document and obtains scanned data;
a printer device that prints out image data;
a personal computer (PC);
a first interface that establishes a Universal Serial Bus (USB) connection between the PC and the scanner device with the PC acting as a host terminal and the scanner device acting as a device terminal; and
a second interface that establishes a USB connection between the scanner device and the printer device with the scanner device acting as the host terminal and the printer device acting as the device terminal.

17. The image processing system according to claim 16, wherein when carrying out a PC printing operation, the scanner device receives print data from the PC by a USB device function and forwards the print data to the printer device by a USB host function.

18. The image processing system according to claim 16, wherein when carrying out a copying operation, the scanner device transmits the scanned data to the printer device by a USB host function, and when carrying out a PC scanning operation, the scanner device transmits the scanned data to the PC by a USB device function.

19. The image processing method according to claim 12, further comprising scanning an original document.

20. The image processing method according to claim 12, further comprising printing out image data.
